(19) United States
(12) Patent Application Publication
(10) Pub. No.: US 2011/0155075 A1
(43) Pub. Date: Jun. 30, 2011

(54) Hawaiian print fabric pet collar, leash and harness

(76) Inventor: Denise Yukie Velasco, Ewa Beach, HI (US)

(21) Appl. No.: 10/369,745

(22) Filed: Aug. 20, 2001

(51) Int. Cl. A01K 27/00

(52) U.S. Cl. 119/795; 119/856

(57) ABSTRACT

These collars, leashes and harnesses are to be made of Hawaiian print fabrics with accessories attached. These Hawaiian prints include all designs such as surfing, floral, fisheries, fruits, tapa, ancient artistry, etc. These fabrics include all types such as cotton, rayon, quilted, heavy grade cotton canvas, etc. These accessories include any and all types such as flowers, fishes, pineapples, coconut trees, turtles, pearls, rhinestones, lace, etc.

### BACKGROUND OF THE INVENTION

Many types of collars, leashes and harnesses are currently available and offered to the public for sale. To date, no one has offered Hawaiian prints made of all types of fabrics with accessories. These collars, leashes and harnesses will offer an entirely new design never before made, described or offered for pet use.

### BRIEF SUMMARY OF THE INVENTION

These collars, leashes and harnesses are to be made of all Hawaiian prints in all types of fabrics. Accessories of any and all designs will be attached to the fabric.

### BRIEF DESCRIPTION OF THE SEVERAL VIEWS OF THE DRAWING

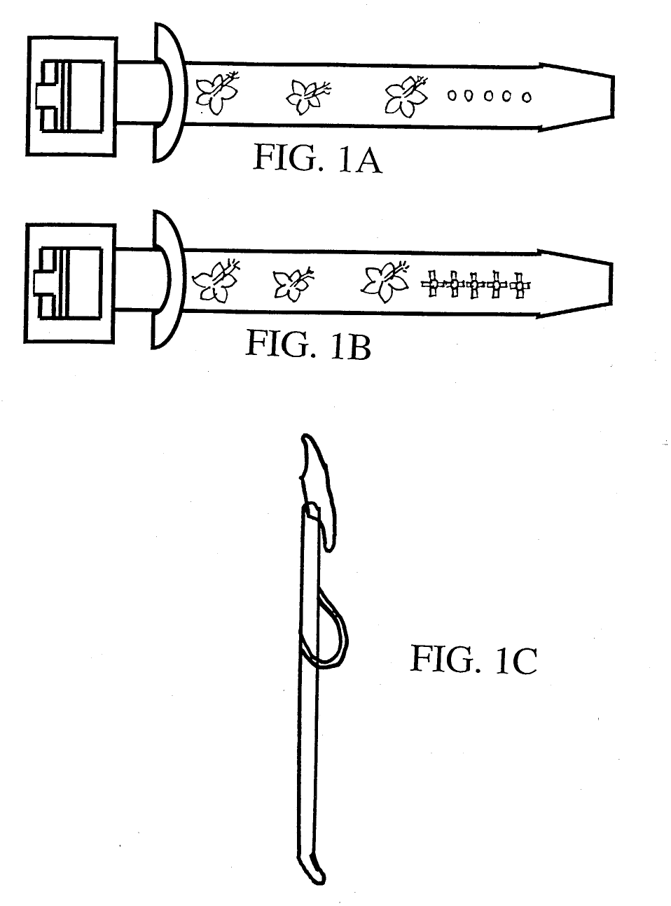

Front view of collar. See FIG. 1A.

Back view of collar. See FIG. 1B.

Side view of collar. See FIG. 1C.

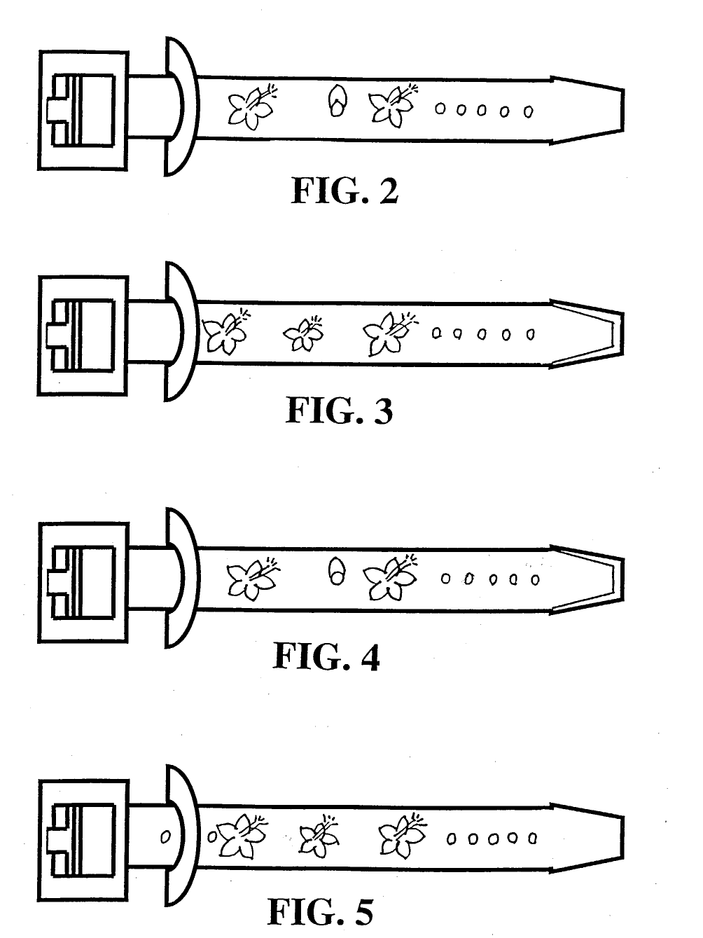

Collar with post and dee swivel hook and u-shaped tip. See FIG. 2.

Collar with metal clasp of u-shaped tip. See FIG. 3.

Collar with post and dee swivel hook and metal clasp of u-shaped tip. See FIG. 4.

Collar with two metal bolts of u-shaped tip. See FIG. 5.

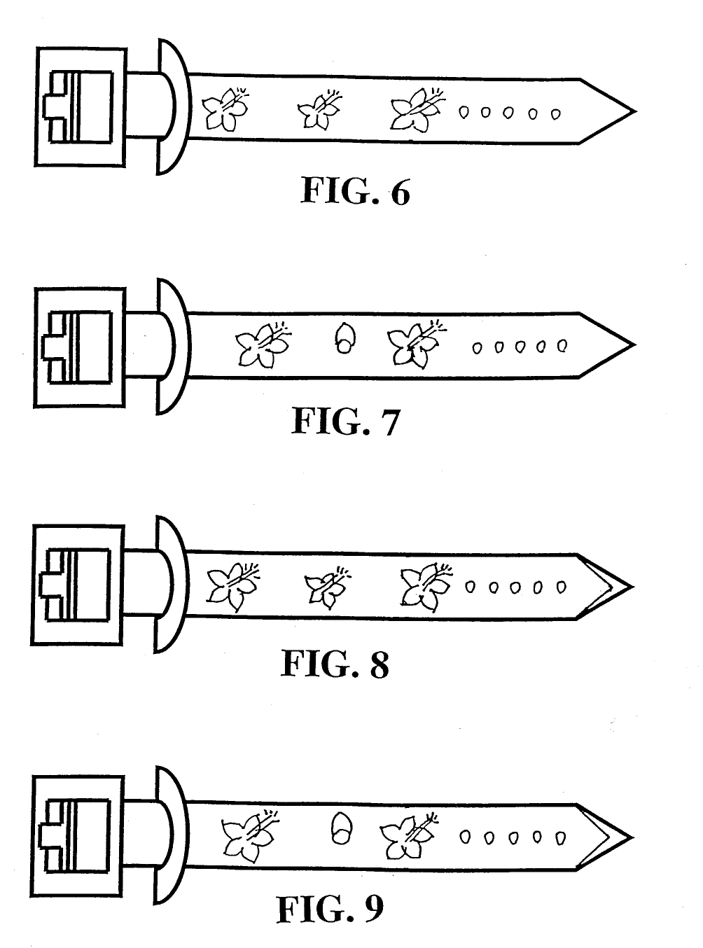

Collar with pointed tip. See FIG. 6.

Collar with post and dee swivel hook and pointed tip. See FIG. 7.

Collar with metal clasp of pointed tip. See FIG. 8.

Collar with two metal bolts, post and dee swivel hook and metal clasp of pointed tip. See FIG. 9.

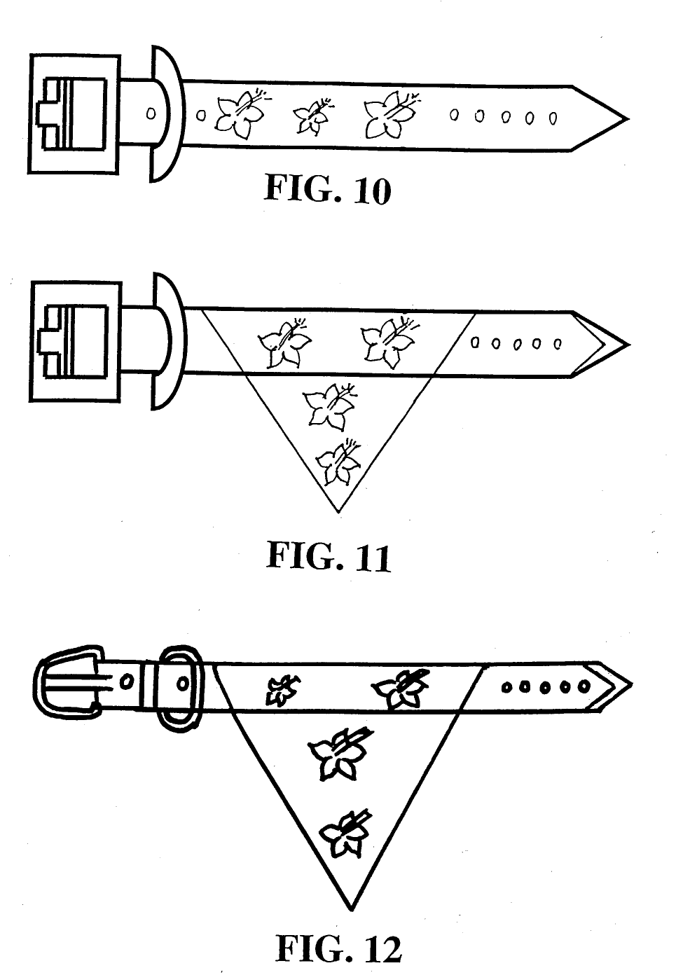

Collar with two metal bolts and pointed tip. See FIG. 10.

Collar with handkerchief and metal clasp of pointed tip. See FIG. 11.

Collar with half buckle, handkerchief and metal clasp of pointed tip. See FIG. 12.

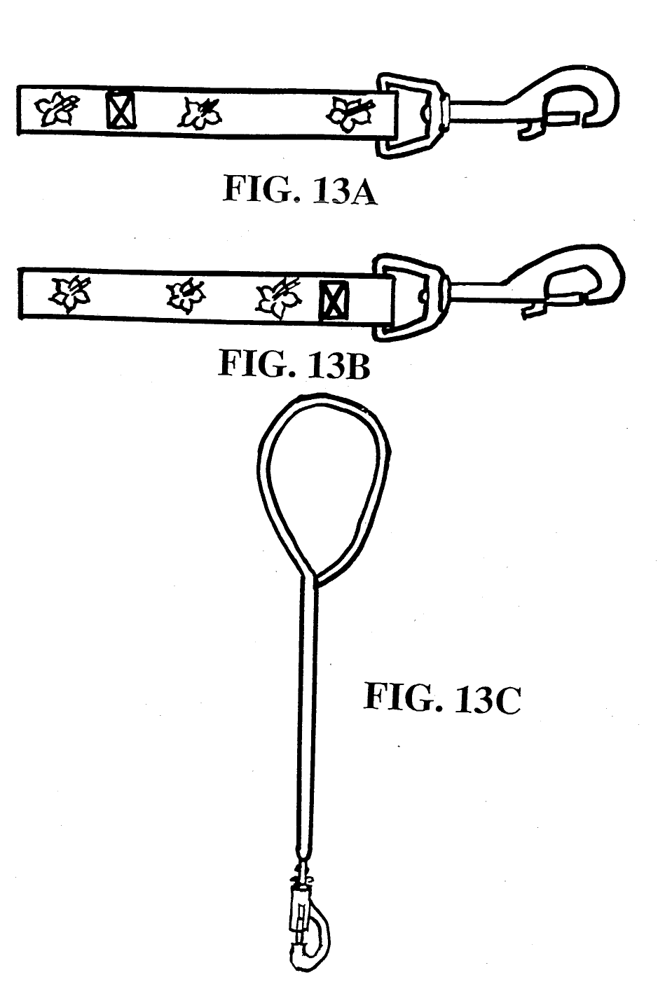

Front view of leash. See FIG. 13A.

Back view of leash. See FIG. 13B.

Side view of leash. See FIG. 13C.

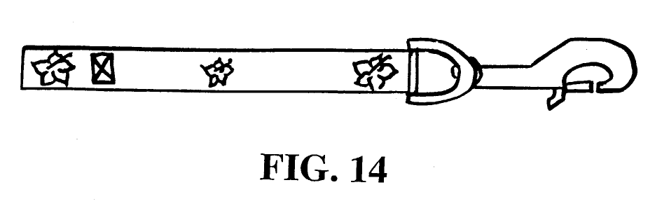

Leash with rounded bottom of snap hook. See FIG. 14.

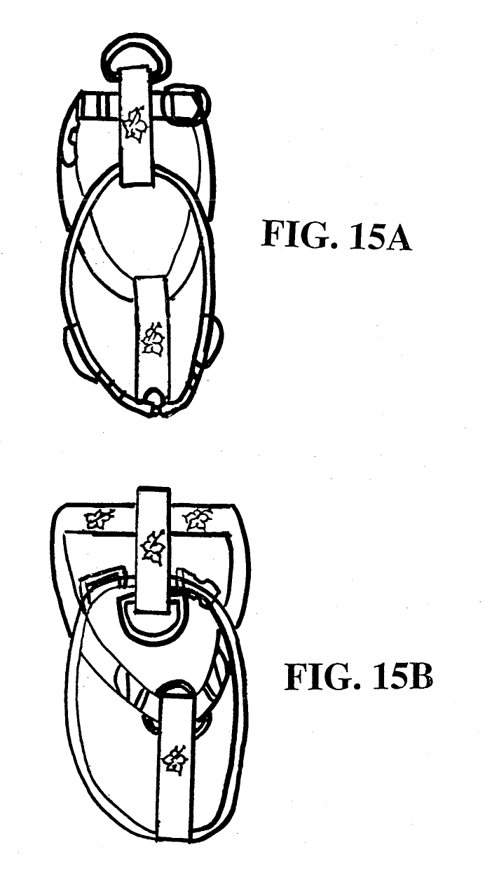

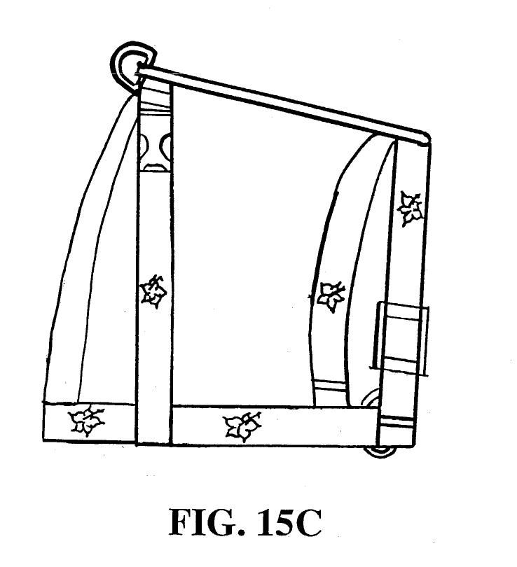

Front view of harness. See FIG. 15A.

Back view of harness. See FIG. 15B.

Side view of harness. See FIG. 15C.

### DETAILED DESCRIPTION OF THE INVENTION

Smaller pets: ⅝″ webbing

Larger pets: 1″ webbing

These collars, leashes and harnesses will be offered in Hawaiian prints to include all designs: surfing, floral, fisheries, fruits, tapa, ancient artistry, etc., of all types of fabric to include cotton, rayon, quilted, heavy grade cotton canvas, etc., with accessories to include all types of items: flowers, fishes, pineapples, coconut trees, turtles, pearls, rhinestones, lace, etc.

For the collar: 14″ length. Cut 18″ of webbing and of fabric. Fabric is sewn to cover the webbing entirely. Slip the buckle onto the end of the collar. Fold over about 2″ of the end back onto itself. Stitch across both pieces from the buckle. Slip the D-ring between the pieces and stitch on the other side of the ring using the box-stitch in leash drawings, securing it in place. The other end of fabric is formed into a u-shaped or pointed tip and stitch on the top. Punch holes for ⅝″ fabric webbing: 1″ from the end for the first hole and approximately ⅜″ in between holes for a total of five holes using a hand-held grommet, punch tool. Punch holes for 1″ fabric-webbing: 2″ from the end for the first hole and approximately 1″ in between holes for a total of four holes. Insert eyelets, in all colors, i.e., blue, white, green, red, brown, silver, gold, etc., and secure in place with grommet, punch tool. The accessories will be sewn or glued to the fabric. Slip the other end of the collar through the other portion of the buckle and back on itself through the self-lock. Adjust size as needed. The collars will be made in lengths of 10″ up to 26″.

For the leash: 4′ length. Cut approximately 4′ 3″ of webbing and of fabric. Fabric is sewn to cover the webbing entirely. To make the leash's hand grip: fold over about 7½″ of one end and stitch across both pieces using box-stitch in leash drawings. Thread the other end of the leash through the swivel snap and fold the end back on itself about 1½″. Stitch across both pieces using box-stitch in leash drawings. The leashes will be made in lengths of 4′ and 6′.

For the harness: small. Cut two 24″ of webbing and of fabric. Cut two 7″ of webbing and of fabric. Fabric is sewn to cover the webbing entirely. Thread the 24″ fabric through the buckle, clamp, harness snap and again through clamp then through the middle bar of buckle. Fold over about 1½″ of the end back onto itself. Stitch across both pieces. Slip the other end of fabric through the other portion of the harness snap and back on itself. Stitch across both pieces. Thread the second 24″ fabric through the buckle, clamp, O-ring and again through clamp then through the middle bar of buckle. Fold over about 1½″ of the end back onto itself. Stitch across both pieces. Repeat this procedure for the other end of fabric. Slip the D-ring onto the end of 7″ fabric. Fold over about 2½″, onto the 24″ fabric with the O-ring, of the end back onto itself. Fold over about 2″ of the other end, onto the 24″ fabric with harness snap between the clamp and buckle with the D-ring resting on top, back onto itself. Use box-stitch or glue across three pieces. Thread the second 7″ fabric through the O-ring and fold over about 1½″ back on itself. Fold over about 2½″ of the other end, onto the 24″ fabric with harness snap, back on itself. Use box-stitch or glue across three pieces. Adjust size as needed.

1) These collars, leashes and harnesses are to be made with Hawaiian print fabrics and accessories.

2) Said Hawaiian prints are to include any and all designs.

3) Said designs are to include such items as surfing, floral, fisheries, fruits, tapa, ancient artistry, etc.

4) Said fabrics are to include any and all types.

5) Said fabrics are to include such types as cotton, rayon, quilted, heavy grade cotton canvas, etc.

6) Said accessories are to include any and all styles of choice.

7) Said accessories are to include such items as flowers, fishes, pineapples, coconut trees, turtles, pearls, rhinestones, lace, etc.

8) These collars, leashes and harnesses are to be made with any and all types and styles of hardware.

9) Said types of hardware are to include such items as zinc die cast, mallable iron casting, bronze casting, etc.

10) Said styles of hardware are to include such items as buckles, rings, post and dee swivel hooks, clasps, bolts, snaps, eyelets of all colors, i.e., blue, white, green, red, brown, silver, gold, etc. and webbing of all types of widths, lengths, prints, stitches, fabrics, etc.

11) These collars, leashes and harnesses are to be made into any and all styles of choice utilizing the Hawaiian print fabrics and accessories.

12) Said styles are to include the handkerchief, etc.
